(19) United States
(12) Patent Application Publication
(10) Pub. No.: US 2019/0073347 A1
(43) Pub. Date: Mar. 7, 2019

(54) LOCKSCREEN NOTE-TAKING

(71) Applicant: Google Inc., Mountain View, CA (US)

(72) Inventors: Thomas Buckley, San Francisco, CA (US); Maria Cirimele, East Palo Alto, CA (US)

(21) Appl. No.: 15/694,729

(22) Filed: Sep. 1, 2017

(51) Int. Cl. G06F 17/24; G06F 21/31

(52) U.S. Cl. CPC G06F 17/242; G06F 3/04817; G06F 21/31

(57) ABSTRACT

A note-taking application may be provided as a unified package that includes a full application for an unlocked state of the device, and a limited application for a locked state of the device. A user may perform a trigger action, such as swiping down from a corner, when the device is in a standby mode or displaying a lock screen. In response to the trigger action, the device may execute the limited application, allowing the user to write notes while the device remains in a locked state. The limited application accesses a sandboxed local note store with configurable note persistence, but can communicate with the full application by using secure API calls.

### BACKGROUND

Pen enabled devices are becoming more commonplace and display digitizers are becoming standardized components of laptop computers and other computing devices. Pen input is well suited to quickly memorialize ideas and inspirations as they come to a user, particularly ideas that may be more easily expressed visually as a drawing or sketch. However, since it is difficult for many users to predict when inspiration may arise, effective use of pen enabled devices may prove to be challenging.

For example, pen enabled devices may enter into a locked state automatically after a period of inactivity, or the user may manually lock the device, for example when the user is at a meeting. When the user wants to write a note using a locked device, the user may first be presented with a lock screen that requests a PIN, password, biometrics, or other credentials. The user provides the requested credentials to unlock the device, and launches a note taking application to begin writing a note. This process can take the user away from their thought processes, which discourages spontaneous note-taking with the pen enabled device.

### SUMMARY

Aspects of the subject technology provide systems and methods for providing a note-taking application that is accessible from a logged in, locked state of a pen enabled device. A note-taking application may be provided as a unified package that includes a full application for an unlocked state of the device, and a limited application for a locked state of the device. A user may perform a trigger action, such as swiping down from a corner, when the device is in a standby mode or displaying a lock screen. In response to the trigger action, the device may execute the limited application, allowing the user to write notes while the device remains in a locked state. The limited application accesses a sandboxed local note store with configurable note persistence, but can communicate with the full application by using secure API calls.

Aspects of the subject technology provide a method for accessing a note taking application from a locked computing device. The method includes detecting a trigger action while a computing device is in a locked state for a user account. The method further includes providing for display, on a display device, a note editor in response to detecting the trigger action. The method further includes receiving, from the display device, user input for the note editor while the computing device remains in the locked state for the user account. The method further includes storing, into a local note store associated with the user account, a note based on the user input, wherein the local note store is separate from locked data of the user account that is accessible from the computing device in an unlocked state.

Aspects of the subject technology provide a system for accessing a note taking application from a locked computing device. The system includes one or more processors, and a machine-readable medium including instructions stored therein, which when executed by the processors, cause the processors to perform operations including detecting a trigger action while a computing device is in a locked state for a user account. The operations further include providing for display, on a display device, a note editor in response to detecting the trigger action. The operations further include receiving, from the display device, user input for the note editor while the computing device remains in the locked state for the user account. The operations further include storing, into a local note store associated with the user account, a note based on the user input, wherein the local note store is separate from locked data of the user account that is accessible from the computing device in an unlocked state.

Aspects of the subject technology provide a non-transitory machine-readable medium, which when executed by one or more processors, cause the processors to perform operations for accessing a note taking application from a locked computing device. The operations include detecting a trigger action while a computing device is in a locked state for a user account. The operations further include providing for display, on a display device, a note editor in response to detecting the trigger action. The operations further include receiving, from the display device, user input for the note editor while the computing device remains in the locked state for the user account. The operations further include storing, into a local note store associated with the user account, a note based on the user input, wherein the local note store is separate from locked data of the user account that is accessible from the computing device in an unlocked state.

Further aspects of the subject technology, features, and advantages, as well as the structure and operation of various aspects of the subject technology are described in detail below with reference to accompanying drawings.

### BRIEF DESCRIPTION OF THE FIGURES

Aspects of the subject technology are described with reference to the accompanying drawings. In the drawings, like reference numbers may indicate identical or functionally similar elements.

FIG. 1 depicts a diagram of a system for providing access to a note taking application from a locked computing device, according to aspects of the subject technology.

FIG. 2A depicts a user interface for a lock screen of a device, according to aspects of the subject technology.

FIG. 2B depicts a user interface for a limited note taking application executing while a device remains in a locked state, according to aspects of the subject technology.

FIG. 2C depicts a user interface of an operating system displaying notifications triggered by a full note taking application after a device is unlocked, according to aspects of the subject technology.

FIG. 2D depicts a user interface for a full note taking application executing after a device is unlocked, according to aspects of the subject technology.

FIG. 3 shows a flowchart illustrating a method for providing access to a note taking application from a locked computing device, according to aspects of the subject technology.

FIG. 4 conceptually illustrates an example electronic system with which some implementations of the subject technology can be implemented.

### DETAILED DESCRIPTION

While aspects of the subject technology are described herein with reference to illustrative examples for particular applications, it should be understood that the subject technology is not limited to those particular applications. Those skilled in the art with access to the teachings provided herein will recognize additional modifications, applications, and aspects within the scope thereof and additional fields in which the subject technology would be of significant utility.

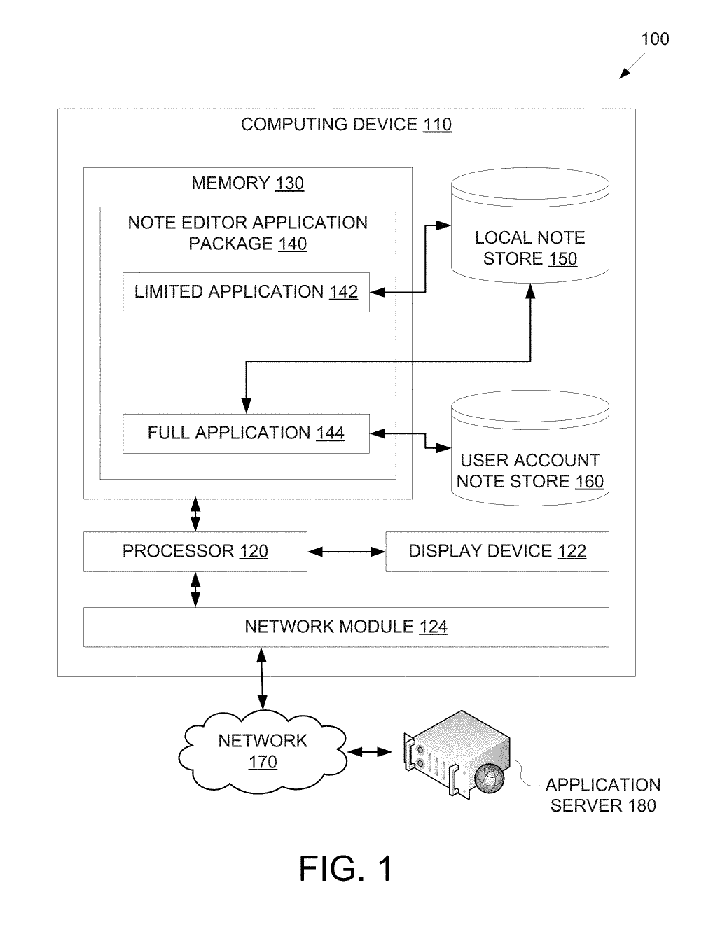

FIG. 1 illustrates an exemplary system 100 for providing access to a note taking application from a locked computing device, according to aspects of the subject technology. System 100 includes computing device 110, network 170, and application server 180. Computing device 110 may be coupled to application server 180 over network 170.

Computing device 110 includes processor 120, display device 122, network module 124, memory 130, local note store 150, and user account note store 160. Memory 130 includes note editor application package 140, which includes limited application 142 and full application 144. Note that while local note store 150 and user account note store 160 are shown as separate logical storage entities, they may both be stored on the same physical storage media.

In aspects of the subject technology, computing device 110 is a pen enabled device that may receive pen input from display device 122. For example, computing device 110 may be a desktop all-in-one computer, tablet or convertible computer, laptop computer, smart phone, portable gaming console, or other device having a display device 122 supporting pen input.

In this description, pen input is used to refer generally to input from a pen or a stylus that can interface with display device 122 of computing device 110. This includes active devices with circuitry as well as passive devices. The pen may interface with capacitive or resistive touchscreens, display digitizers, peripheral tablet devices, or other input devices coupled to or integrated with display device 122. In some aspects of the subject technology, display device 122 may correspond to a display projector or augmented reality eyewear, in which case the pens may correspond to air pens that provide pen input without contacting a physical surface.

A user desiring to take notes with computing device 110 may, for example, access an application storefront supported by application server 180 to download and install note editor application package 140 onto computing device 110. Thus, computing device 110 may utilize network module 124, for example an Ethernet adapter, wireless card or cellular modem, to communicate with application server 180 over network 170. In aspects of the subject technology, note editor application package 140 may be provided on installable media, for example on an optical disc, flash memory card, or other device. In other aspects of the subject technology, note editor application package 140 may be preinstalled onto computing device 110, or note editor application package 140 may be integrated as part of an operating system of computing device 110.

As shown in FIG. 1, the note editor application package 140 includes at least two components: a limited application 142, which corresponds to a note taking application that runs while computing device 110 is in a locked state, and full application 144, which corresponds to a note taking application that runs while computing device 110 is in an unlocked state. Note that while FIG. 1 illustrates both limited application 142 and full application 144 in memory 130, in other aspects of the subject technology, limited application 142 and full application 144 may be individually loaded on demand into memory 130, for example to reduce memory usage.

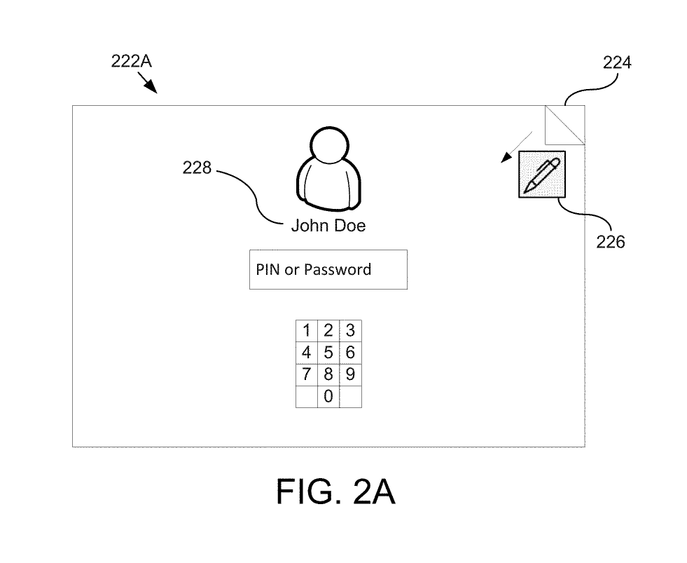

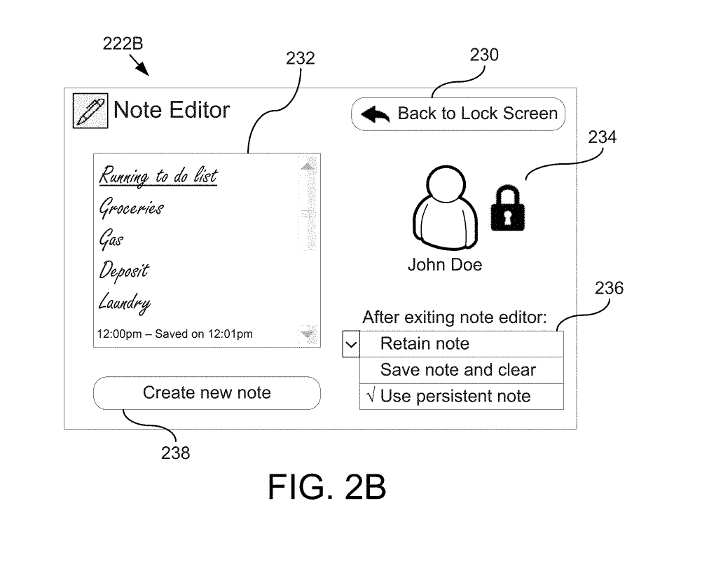

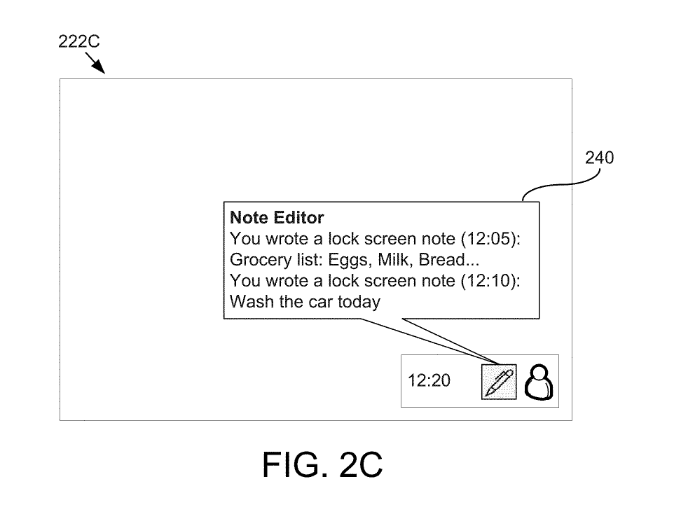

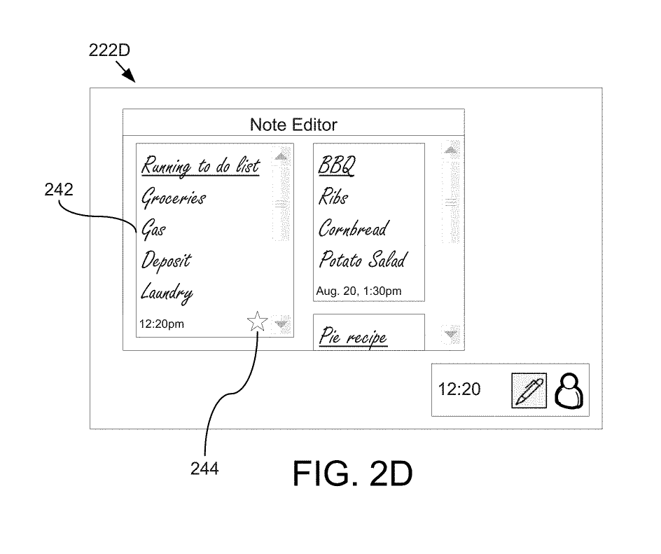

Limited application 142 may provide limited functionality compared to full application 144, for example by providing a reduced feature set and/or a simplified interface more suitable for quick note taking. However, since both limited application 142 and full application 144 are part of the same unified application, or note editor application package 140, a consistent look and feel may still be presented to the user, and the applications may present the same application name or title to the user (see e.g. “Note Editor” in FIG. 2B, FIG. 2C and FIG. 2D) without presenting any distinctions between the limited and full versions.

Note editor application package 140 may be executed in the context of a user account of a particular user. This user account may be secured against unauthorized access by an authentication requirement, such as by username and password, personal identification number (PIN), biometric indicators such as a fingerprint, or another credential. A data profile associated with the user account may store data associated with the user account, and may be encrypted for additional security. This data profile may include user account note store 160, which contains notes stored and managed by full application 144. Data within the data profile is accessible while the user is logged into the user account and computing device 110 is in an unlocked state.

Note that limited application 142 is not granted direct access to user account note store 160. Instead, limited application 142 is granted access to local note store 150, which is separate and sandboxed from user account note store 160. Local note store 150 may further be associated with the user account, rather than being shared with all users of computing device 110.

Limited application 142 and full application 144 may communicate with each other using API calls. API calls may be defined for secured communications within a unified application, such as note editor application package 140. API calls can use intermediate storage, such as local note store 150, to store and retrieve API messages. API calls may be defined for adding and removing API messages from message queues that are reserved for each application within a unified application. The API messages may be encrypted.

For example, limited application 142 can communicate with full application 144 by using API calls to store API messages in a first message queue of local note store 150. When full application 144 becomes active, full application 144 may use API calls to retrieve API messages from the first message queue in local note store 150. Full application 144 may process the retrieved API messages. Similarly, full application 144 can communicate with limited application 142 by using API calls to store API messages in a second message queue of local note store 150. When limited application 142 becomes active, limited application 142 may use the API calls to retrieve the API messages from the second message queue in local note store 150. Limited application 142 may process the retrieved API messages.

With an overview of system 100 now in place, it may be helpful to examine the operation of limited application 142 in greater detail. Prior to an installation of limited application 142, a lock screen of computing device 110 may be limited to providing methods of unlocking computing device 110. After note editor application package 140 is installed into computing device 110, the lock screen of computing device 110 may be augmented with additional features for accessing limited application 142. Some of these additional features are illustrated in the lock screen depicted in FIG. 2A.

FIG. 2A depicts a user interface 222A for a lock screen of a device, according to aspects of the subject technology. User interface 222A includes a corner 224, an application icon 226, and a user account 228. Referring to FIG. 2A and FIG. 1, user interface 222A may correspond to a user interface shown on display device 122 of FIG. 1 when computing device 110 is in a locked state.

As shown in user interface 222A, a user account 228 or “John Doe” is already logged into computing device 110, but since computing device 110 is in a locked state for user account 228, user interface 222A prompts the user to enter credentials, such as a PIN or password, to unlock computing device 110. However, as an alternative to unlocking computing device 110 to access full application 144, the user may access a note editor of limited application 142 by performing a trigger action.

According to some aspects of the subject technology, processor 120 may execute limited application 142 in the background while computing device 110 is in a locked state. In this case, limited application 142 provides one or more modifications to the lock screen to enable access to the note editor via the trigger action. Limited application 142 may also perform the detecting of the trigger action. In other aspects of the subject technology, an operating system of computing device 110 may determine installed applications having lock screen compatible applications. The operating system may also perform the detecting of trigger actions for those compatible applications.

The triggering action may correspond to a touch gesture, such as swiping down from corner 224, when display device 122 is a touch sensitive device. Another action may correspond to interacting with a user interface element, such as tapping application icon 226 with a touch or a mouse click. Yet another action may correspond to pen movements, such as removing a pen from an integrated pen holder of computing device 110, bringing the pen into proximity of display device 122, or touching display device 122 with the pen. While these examples are described in conjunction with user interface 222A, actions may also be detected when display device 122 is off or dimmed in a low power state.

Once the trigger action is detected, user interface 222A of FIG. 2A may transition to user interface 222B of FIG. 2B. A screen transition effect similar to turning a page of a book may be provided, but any suitable transition may be utilized. Note that while the lock screen is replaced entirely in this example, other aspects of the subject technology may display user interface 222B as a part of user interface 222A.

When limited application 142 is not already executing, then an operating system of computing device 110 may cause processor 120 to execute limited application 142 in response to the trigger action, for example by creating a new process or by resuming a prior suspended process. User interface 222A may thus be replaced with a user interface displaying an execution of limited application 142, as shown in FIG. 2B.

FIG. 2B depicts a user interface 222B for a limited note taking application executing while a device remains in a locked state, according to aspects of the subject technology. User interface 222B of FIG. 2B includes back button 230, note 232, user account 234, persistence setting 236, and new note button 238. Referring to FIG. 2B and FIG. 1, user interface 222B may correspond to a user interface shown on display device 122 of FIG. 1 when computing device 110 executes limited application 142 while remaining in a locked state.

For simplicity, user interface 222B may provide one note at a time, or note 232, for editing by the user. However, alternative aspects of the subject technology may support more than one note at a time. Limited application 142 may store note 232 in local note store 150. Note 232 may initially be blank, and the user may write freeform notes using a pen, including text, drawings, or anything else the user wants to memorialize. Thus, referring to FIG. 1, display device 122 may receive user input corresponding to pen input from the user, or a running to do list as shown in note 232. Note that the user input is received while computing device 110 remains in a locked state, as indicated by user account 234 showing a locked icon. Further, as shown in note 232, user interface 222B may provide a time and date when note 232 was created and when note 232 was last saved to non-volatile storage, such as to local note store 150.

A new note button 238 is provided to allow the user to indicate when note 232 is complete and a new note is ready to be written, for example to write about a different topic or to otherwise provide a logical break in the notes. When the user utilizes new note button 238, then note 232 may be saved to user account note store 160, for example by sending a message to full application 144 via API calls. Note 232 may then be removed or deleted from local note store 150, and a new empty note may appear in user interface 222B. This process may be considered to be a manual flushing of note 232 from local note store 150 into user account note store 160.

If the user does not utilize new note button 238, then the user may utilize back button 230 to transition back to the lock screen of user interface 222A. The user may also place computing device 110 into a lower power state, such as a standby mode, a low power mode, or an off state. Alternatively, power saving settings of computing device 110 may cause an automatic transition after a timeout to the lock screen or the lower power state. In each of these situations, limited application 142 becomes inactive and may close or suspend. However, before limited application 142 becomes inactive, an action may be performed on note 232 based on persistence setting 236.

As shown in user interface 222B, persistence setting 236 may be set according to user preference. In a first option of persistence setting 236, or “retain note”, note 232 may be persisted to local note store 150 after limited application 142 becomes inactive, or “after exiting note editor”. Thus, when the user returns to limited application 142 at a later time, the contents of note 232 may be retrieved from local note store 150 and presented to the user in user interface 222B. Since there is a risk of note 232 being observed by a third party as entry into limited application 142 is not secured by user authentication, the “retain note” setting may be most appropriate for working with notes that the user does not mind being potentially made public, such as grocery lists or other less sensitive information.

In a second option of persistence setting 236, or “save note and clear”, note 232 may be saved to user account note store 160 after limited application 142 becomes inactive, or “after exiting note editor”. After saving, note 232 may be cleared and deleted from local note store 150. Thus, the “save note and clear” setting may perform the same actions as when the user utilizes new note button 238, as described above. This process may be considered to be an automatic flushing of note 232 from local note store 150 into user account note store 160. The “save note and clear” setting may be most appropriate for working with high confidentiality notes as a third party cannot easily access note 232 once note 232 is flushed to user account note store 160, where note 232 can be protected as encrypted data within the user account's data profile.

For a third option of persistence setting 236, or “use persistent note”, note 232 may be saved to user account note store 160 after limited application 142 becomes inactive, or “after exiting note editor”. However, unlike the “save note and clear” setting, note 232 may be retained in local note store 150. Further, when changes are made to the flushed note by full application 144, the changes may be synchronized back to note 232 in local note store 150. Accordingly, the “user persistent note” setting may be most appropriate for a note that the user anticipates editing while in both the locked and unlocked states of computing device 110, such as a running to do list.

It should be noted that the elements of user interface 222B are all optional with the exception of a note editor for editing note 232. Thus, back button 230 may be omitted, user account 234 may be omitted, persistence setting 236 may be omitted, and new note button 238 may be omitted. In some aspects of the subject technology, features shown in user interface 222B may be moved to a user interface of full application 144. For example, persistence setting 236 may be set in a preferences window provided by full application 144. In this case, persistence setting 236 may be communicated from full application 144 to limited application 142 using API calls.

Having illustrated the operation of limited application 142, it may be helpful to examine how limited application 142 and full application 144 communicate with each other in the context of a unified application, or note editor application package 140. As discussed above in reference to FIG. 1, limited application 142 utilizes API calls to communicate with full application 144, rather than directly accessing user account note store 160. Similarly, in the other direction, full application 144 utilizes API calls to communicate with limited application 142, rather than directly accessing local note store 150. Examples of these communications are described in further detail below in conjunction with FIG. 2C and FIG. 2D.

FIG. 2C depicts a user interface 222C of an operating system displaying notifications triggered by a full note taking application after a device is unlocked, according to aspects of the subject technology. User interface 222C includes notification 240.

Before user interface 222C is shown, a number of actions may have already occurred. The user may have entered limited application 142 and selected the “save note and clear” setting in persistence setting 236. At time 12:05, the user may have written a new note concerning a grocery list. After writing the note, the user may have used new note button 238 to manually flush the note. Alternatively, the user may have closed limited application 142 by returning to the lock screen or placing computing device 110 into a lower power state. Since persistence setting 236 is set to “save note and clear”, the grocery list note is automatically flushed when limited application 142 closes. At time 12:10, the user may have written a new note concerning a reminder to “wash the car today”, which may be flushed in a similar manner.

More specifically, each manual or automatic flushing may be carried out by limited application 142 sending a message to full application 144 via API calls. Each message may include note contents and associated metadata, which can include note and message identifiers, a creation date and timestamp, a message sending time, a message flushing time, and a context for the message. These messages may be sent immediately upon flushing, or may be stored in a queue for sending after computing device 110 transitions from a locked state to an unlocked state, and vice versa.

The note contents in each message may include an entirety of the note, or may alternatively include a delta update for updates to existing notes. The context in each message may indicate a surrounding context that triggered the sending of the message. For example, the context may indicate whether the user used new note button 238 to cause a manual flushing, or whether limited application 142 closed and caused an automatic flushing due to a power saving timeout or a transition to a lock screen or a lower power mode.

Once the user unlocks computing device 110, for example by providing user credentials of a password or PIN as shown in FIG. 2A, then an operating system of computing device 110 may trigger full application 144 to process any messages that may have been sent using API calls. Full application 144 may be executing in the background, in which case full application 144 can wake up and resume execution. However, if full application 144 is not actively executing, then the operating system of computing device 110 may cause full application 144 to begin executing so that it can receive and process the messages. In aspects of the subject technology, full application 144 may provide a lightweight message processing module to process the messages, allowing deferred execution of a full featured note editing application.

For each received message, full application 144 may create a new note or update an existing note within user account note store 160. Further, full application 144 may determine an appropriate action to perform based on the metadata and the context in each message. For example, processor 120 may calculate a weighted sum for each of the messages, wherein older sending times are assigned more points compared to more recent sending times, and wherein automatic flushing is lower weighted compared to manual flushing. If the weighted sum exceeds a threshold value, then full application 144 may conclude that the associated note is a lower priority note and that sending a notification may be the most appropriate action. The threshold value may be global for all users, user specific, or user defined.

To provide an example weighting, sending times may be assigned a value of 1 point per minute in the past, automatic flushing may be assigned a 2× weight, manual flushing may be assigned a 1× weight, and the threshold value may be set to 5. The received messages may include context indicating that the notes were both automatically flushed, and metadata may indicate sending times of 12:05 and 12:10, or 15 and 10 minutes in the past compared to the current time of 12:20. Thus, the weighted sums may correspond to 15(2)=30 for the 12:05 note, and 10(2)=20 for the 12:10 note. Since both 30 and 20 exceed the threshold value of 5, full application 144 may conclude that the notes are lower priority notes and determine that the appropriate action is to send a notification. Of course, this is an example for processing the messages, and any suitable method may be utilized to determine the appropriate actions.

Once full application 144 decides a notification is the most appropriate action, full application 144 may send a notification to an operating system, which in turn notifies the user as shown in notification 240 of FIG. 2C. As shown in notification 240, the notification may include an indication that the note was written while computing device 110 was in a locked state, a time that the note was written, and a summary of the note, which may include portions of text or drawings from the note. In aspects of the subject technology, text in the note may be processed through optical character recognition (OCR) to provide text in a consistent font, as shown in notification 240. The user may then decide whether to continue editing the notes or to defer action until later. For example, if the operating system detects a tapping or clicking on notification 240, then an associated note may be opened up for editing in full application 144.

In another example, full application 144 may decide that automatically opening a note for editing in full application 144 is the most appropriate action. Referring to FIG. 2B, the user may use new note button 238 to manually flush note 232. The user may then use back button 230 to return to the lock screen of user interface 222A, and proceed to unlock computing device 110. Alternatively, the user may tap on the lock icon of user account 234, and a login popup may appear on user interface 222B, wherein the user can proceed to unlock computing device 110. After unlocking computing device 110, user interface 222A or 222B may transition to the user interface shown in FIG. 2D.

FIG. 2D depicts a user interface 222D for a full note taking application executing after a device is unlocked, according to aspects of the subject technology. User interface 222D includes note 242 and indicator 244.

After receiving an incoming API message containing note 232, full application 144 may create or update a corresponding note 242 in user account note store 160, wherein note 242 is synchronized with content from note 232. Full application 144 may further examine the metadata and context of the incoming API message and observe that note 232 was manually flushed on user interface 222B at 12:20, or more specifically at 12:20, zero (0) seconds. The current time may be ascertained to be 12:20, thirty (30) seconds.

Using the same example weighting described above with respect to FIG. 2C, a weighted sum can be calculated as 0.5(1)=0.5 for note 232. Since 0.5 does not exceed the threshold value of 5, full application 144 may conclude that note 232 is a high priority note, and may thus determine the most appropriate action is to automatically open a note editor application window for the note.

Since full application 144 does not have direct access to note 232 in local note store 150, full application 144 may instead work with its own corresponding copy, or note 242 in user account note store 160. Accordingly, as shown in user interface 222D, a note editor application window is opened automatically with note 242 displayed for editing, along with any other notes the user may have stored in user account note store 160, such as the BBQ list and pie recipe notes.

Recall that persistence setting 236 was set to “use persistent note” in FIG. 2B. Thus, when full application 144 stores note 242 into user account note store 160, stored metadata may also indicate that note 242 is a “persistent note”, as reflected by indicator 244. Any changes to note 242 can be communicated back to limited application 142 by an additional message via API calls when computing device 110 transitions from an unlocked state into a locked state. Limited application 142 may update its corresponding note 232 in a similar manner as described above.

Instead of receiving a “persistent note” based on persistence setting 236 from limited application 142, a user may also specify a “persistent note” from full application 144, for example by browsing user account note store 160 and marking a particular note to be a “persistent note”. When the user locks computing device 110, then the persistent note can be provided to limited application 142 using API calls, and persistence setting 236 may be automatically set to “use persistent note”.

Note that the examples described above may assume that one note can be indicated to be a “persistent note” at a given time. This restriction may help to secure the user account. The tailored data sharing of a “persistent note” that is updated via API calls between limited application 142 and full application 144 may prevent accidental oversharing of potentially sensitive data.

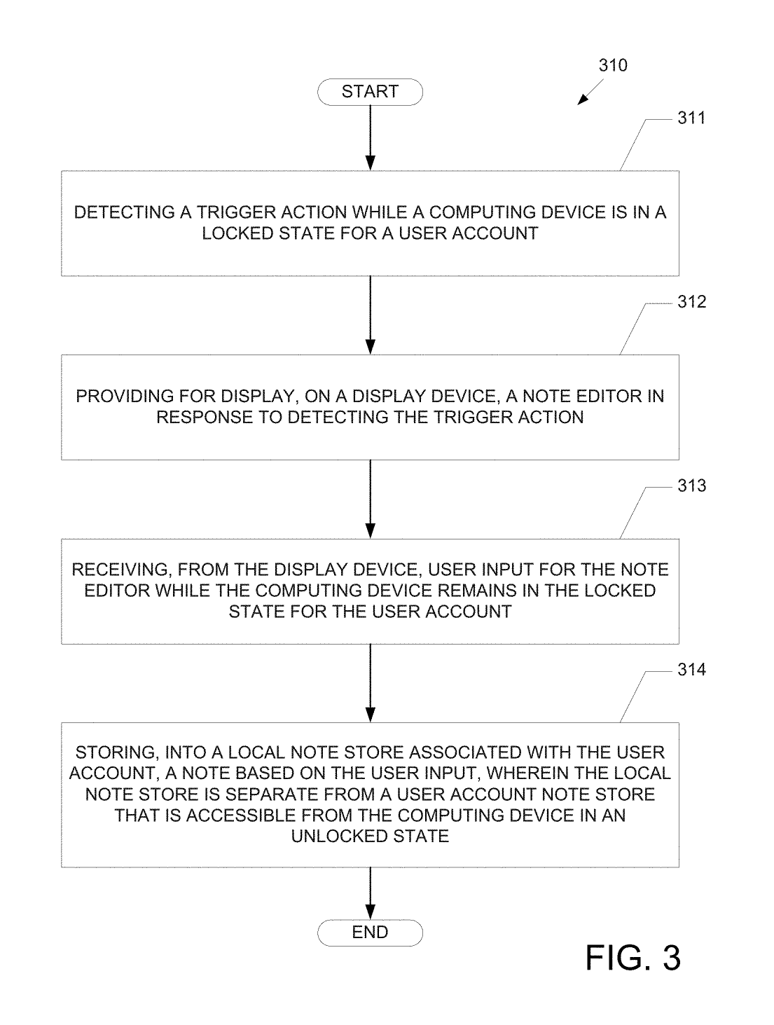

FIG. 3 shows a flowchart illustrating a method 310 for providing access to a note taking application from a locked computing device, according to aspects of the subject technology. At block 311, referring to FIG. 1, processor 120 detects a trigger action while computing device 110 is in a locked state for a user account. As previously described in conjunction with FIG. 2A, the trigger action may include touch gestures, tapping on icons, pen movements, or other actions. Further, the detection of the trigger action may occur while display device 122 is in a dimmed low power or off state.

At block 312, referring to FIG. 1, processor 120 provides for display, on display device 122, a note editor in response to detecting the trigger action of block 311. A user interface of the note editor may appear similar to user interface 222B of FIG. 2B, as described above.

At block 313, referring to FIG. 1, processor 120 receives, from display device 122, user input for the note editor while computing device 110 remains in the locked state for the user account. For example, referring to FIG. 2B, a user may provide user input in the form of pen handwriting corresponding to the content shown in note 232. The user input is received while computing device 110 remains in the locked state for user account 234, or the “John Doe” user account.

At block 314, referring to FIG. 1, processor 120 stores, into local note store 150 associated with the user account, note 232, wherein local note store 150 is separate from user account note store 160 that is accessible from computing device 110 in an unlocked state. Continuing with the “John Doe” user account example, the local note store 150 is associated with the “John Doe” user account, but is separate from user account note store 160 that is accessible from computing device 110 in an unlocked state.

Block 314 may be triggered in response to a user action, such as triggering new note button 238, triggering back button 230, or pressing a power or standby button of computing device 110. Block 314 may also be triggered in response to an automatic action, such as a power saving timeout back to a lock screen or to a lower power state. Further, as discussed above in conjunction with FIG. 2C and FIG. 2D, after storage into local note store 150, note 232 may be further communicated and synchronized between limited application 142 and full application 144 via API calls.

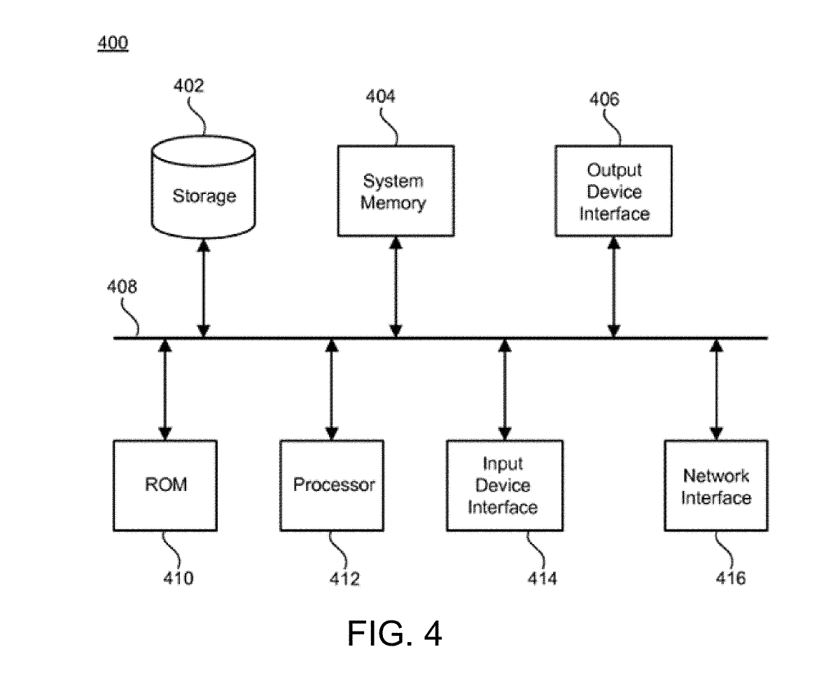

FIG. 4 conceptually illustrates an example electronic system with which some implementations of the subject technology can be implemented. Electronic system 400 can be a computer, phone, PDA, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (for example, a magnetic or optical disk and its corresponding disk drive) as permanent storage device 402.

Other implementations use a removable storage device (for example, a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, or ROM 410. For example, the various memory units include instructions for processing a social endorsement for an item in accordance with some implementations. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, for example, cathode ray tubes (CRT) or liquid crystal displays (LCD). Some implementations include devices, for example, a touchscreen that functions as both input and output devices.

Finally, as shown in FIG. 4, bus 408 also couples electronic system 400 to a network (not shown) through a network interface 416. In this manner, the computer can be a part of a network of computers (for example, a local area network (“LAN”), a wide area network (“WAN”), or an Intranet, or a network of networks, for example, the Internet. Any or all components of electronic system 400 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Aspects of the subject technology described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In aspects of the subject technology, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in aspects of the subject technology described above should not be understood as requiring such separation in all aspects of the subject technology, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A computer-implemented method comprising:
detecting a trigger action while a computing device is in a locked state for a user account;
providing for display, on a display device, a note editor in response to detecting the trigger action;
receiving, from the display device, user input for the note editor while the computing device remains in the locked state for the user account; and
storing, into a local note store associated with the user account, a note based on the user input, wherein the local note store is separate from a user account note store that is accessible from the computing device in an unlocked state.

2. The method of claim 1, further comprising:
prior to suspending the note editor, performing an action on the note in the local note store based on a persistence setting.

3. The method of claim 2, wherein the persistence setting is to retain notes, and wherein the action on the note is retaining the note in the local note store.

4. The method of claim 2, wherein the persistence setting is to save notes and clear, and wherein the action on the note comprises:
sending, to a full note editor application, an API message that includes the note; and
deleting the note from the local note store.

5. The method of claim 4, further comprising:
unlocking the computing device for the user account; and
triggering the full note editor application to process the API message based on metadata and context stored in the API message.

6. The method of claim 5, further comprising:
providing for display, on the display device, a notification for the note based on the processed API message.

7. The method of claim 5, further comprising:
providing for display, on the display device, a note editor application window that includes the note based on the processed API message.

8. The method of claim 2, wherein the persistence setting is to use a persistent note, and wherein the action on the note comprises:
sending an API message that includes the note;
retaining the note in the local note store;
receiving an additional API message that includes one or more modifications to the note; and
updating the note in the local note store according to the one or more modifications.

9. The method of claim 1, wherein the trigger action comprises one of: removing a pen from a pen holder of the computing device, performing a gesture on the display device, or interacting with an icon displayed on the display device.

10. A system for providing lock screen note taking, the system comprising:
a memory comprising instructions; and
a processor configured to execute the instructions to:
detect a trigger action while a computing device is in a locked state for a user account;
provide for display, on a display device, a note editor in response to detecting the trigger action;
receive, from the display device, pen input for the note editor while the computing device remains in the locked state for the user account;
store, into a local note store associated with the user account, a note based on the pen input, wherein the local note store is separate from a user account note store that is accessible from the computing device in an unlocked state; and
prior to suspending the note editor, perform an action on the note in the local note store based on a persistence setting.

11. The system of claim 10, wherein the processor is further configured to:
set the persistence setting based on a user input.

12. The system of claim 10, wherein the persistence setting is to retain notes, and wherein the action on the note is retaining the note in the local note store.

13. The system of claim 10, wherein the persistence setting is to save notes and clear, and wherein the action on the note comprises:
sending, to a full note editor application, an API message that includes the note; and
deleting the note from the local note store.

14. The system of claim 13, wherein the processor is further configured to:
unlock the computing device for the user account; and
trigger the full note editor application to process the API message based on metadata and context stored in the API message.

15. The system of claim 14, wherein the processor is further configured to:
provide for display, on the display device, a notification for the note based on the processed API message.

16. The system of claim 14, wherein the processor is further configured to:
provide for display, on the display device, a note editor application window that includes the note based on the processed API message.

17. The system of claim 10, wherein the persistence setting is to use a persistent note, and wherein the action on the note comprises:
sending an API message that includes the note;
retaining the note in the local note store;
receiving an additional API message that includes one or more modifications to the note; and
updating the note in the local note store according to the one or more modifications.

18. The system of claim 10, wherein the trigger action comprises one of: removing a pen from a pen holder of the computing device, performing a gesture on the display device, or interacting with an icon displayed on the display device.

19. A non-transitory machine-readable storage medium comprising machine-readable instructions for causing a processor to execute a method comprising:
detecting a trigger action while a computing device is in a locked state for a user account;
providing for display, on a display device, a note editor in response to detecting the trigger action;
receiving, from the display device, pen input for the note editor while the computing device remains in the locked state for the user account;
storing, into a local note store associated with the user account, a note based on the pen input, wherein the local note store is separate from a user account note store that is accessible from the computing device in an unlocked state; and
sending, to a full note editor application, an API message that includes the note;
wherein the full note editor application processes the API message upon an unlocking of the computing device.

20. The non-transitory machine-readable storage medium of claim 19, wherein the note editor and the full note editor application are part of a unified application providing a consistent look and feel.
